(19) United States
(12) Patent Application Publication
(10) Pub. No.: US 2012/0009452 A1
(43) Pub. Date: Jan. 12, 2012

(54) NONAQUEOUS ELECTROLYTE SECONDARY BATTERY

(75) Inventor: Atsushi Ueda, Hitachi (JP)

(73) Assignee: HITACHI VEHICLE ENERGY, LTD., Hitachinaka-shi, Ibaraki (JP)

(21) Appl. No.: 13/257,675

(22) PCT Filed: Jul. 20, 2010
(86) PCT No.: PCT/JP2010/004641

§ 371 Date: Sep. 20, 2011

(30) Foreign Application Priority Data
Sep. 1, 2009 (JP) 2009-201321

(51) Int. Cl. H01M 4/131; H01M 10/36

(52) U.S. Cl. 429/94; 429/221; 429/223; 429/224; 429/231.8

(57) ABSTRACT

Disclosed is a nonaqueous electrolyte secondary battery wherein the energy density is improved by increasing the range of depth of discharge to be used. Specifically disclosed is a lithium ion secondary battery 20 wherein an electrode group 6 is contained within a battery case 7. The electrode group 6 is formed by winding a positive electrode plate W1 and a negative electrode plate W3 with a separator W5 interposed therebetween. The positive electrode plate W1 has positive-electrode mixture layers W2 which are formed on both surfaces of an aluminum foil and contain a positive-electrode active material. The positive-electrode active material contains lithium iron phosphate as a principal component. The negative electrode plate W3 has negative-electrode mixture layers W4 which are formed on both surfaces of a rolled copper foil and contain a negative-electrode active material. The negative-electrode active material contains a mixture of a graphite material as a principal component and an amorphous carbon material as a secondary component. The positive electrode plate W1 has a positive-electrode initial charge/discharge efficiency of e1, the negative electrode plate W3 has a negative-electrode initial charge/discharge efficiency of e2, and e1 and e2 satisfy the relation of formula e2=e1−x (10≦x≦20). This avoids usage of the high resistance region of the positive electrode plate W1.

### TECHNICAL FIELD

The present invention relates to nonaqueous electrolyte secondary batteries. Specifically, the present invention relates to a nonaqueous electrolyte secondary battery including a positive electrode including a positive-electrode active material containing a lithium metal phosphate as a principal component and a negative electrode including a negative-electrode active material containing a graphite material as a principal component.

### BACKGROUND ART

Customary nonaqueous electrolyte secondary batteries have mostly adopted lithium cobaltate as a positive-electrode active material. However, lithium cobaltate increases the production cost of batteries when it is used, because material cobalt is produced in a small quantity and is expensive. In addition, such batteries using lithium cobaltate are insufficient in safety upon temperature rise of the batteries during a terminal stage of charging.

For these reasons, attempts have been made to use other lithium compounds such as lithium manganate and lithium nickelate as positive-electrode active materials instead of lithium cobaltate. However, lithium manganate hardly helps the battery to have a sufficient discharge capacity and often suffers from dissolution out of manganese at elevated battery temperatures, thus being problematic. Lithium nickelate causes the battery to have a low discharge voltage and to show a poor thermal stability during the terminal stage of charging, thus also being problematic.

As a possible solution to these problems, lithium iron phosphate (LiFePO₄) and other lithium metal phosphates of olivine crystal structure have been received attention as positive-electrode active materials possibly usable instead of lithium cobaltate, because such lithium metal phosphates release less heat, are more stable at elevated temperatures, and are resistant to dissolution out of metals, as compared to lithium cobaltate. Typically, for improving charge/discharge properties, there have been disclosed techniques using, respectively as a positive-electrode active material, a compound of olivine structure containing an alkali metal (but not containing iron) (see Patent Literature (PTL) 1), a compound of olivine structure containing iron and an alkali metal (see PTL 2), and a compound of olivine structure containing lithium and iron (see PTL 3).

Such lithium metal phosphates having an olivine crystal structure are represented by General Formula LiMPO₄ (wherein M represents at least one metal element selected from the group consisting of Co, Ni, Mn and Fe). They can have an arbitrary battery voltage controlled according to the type of the constituting metal element M. The lithium metal phosphates are advantageous in that they each have a relatively high theoretical capacity of about 140 to 170 mAh/g and can thereby have a large battery capacity per unit mass. In addition and advantageously the resulting batteries can be produced at significantly lower cost when iron is chosen as the metal element M because iron is produced in a large quantity and is inexpensive.

Furthermore, lithium iron phosphate becomes iron phosphate in the state of charge and is known to be highly thermally stable owing to its structure. The lithium iron phosphate can be charged to approximately 100% at a charge cut-off voltage of 3.6 V with reference to metallic lithium and can thereby be charged to 100% at a voltage of 4.2 V or lower which is a decomposition potential of a cyclic carbonate or a chain carbonate used as a principal component of an organic (nonaqueous) electrolyte. Accordingly, the lithium iron phosphate is expected as a positive-electrode active material which less suffers from the decomposition of the organic electrolyte and has satisfactory durability.

However, the lithium iron phosphate has a NASICON structure which is inherently an ion conductor, thereby shows poor electron conductivity and has a rigid crystal structure. For these reasons, the lithium iron phosphate is known to have poor diffusibility of lithium ions, because the diffusion of lithium ions therein is limited and occurs only in a one-dimensional diffusion path. The lithium iron phosphate therefore has a high resistance and is not suitable as a battery material.

As a possible solution to these problems, there is disclosed a technique in which a highly electroconductive carbon material is borne on the surfaces of the lithium iron phosphate particles to improve electron conductivity, the particles are regulated to have sizes of 1 μm or less to shorten the reactive path to thereby improve the reaction rate, and the resulting lithium iron phosphate is allowed to function as a battery material (typically see PTL 4 and PTL 5). Thus, there have been practically used nonaqueous electrolyte secondary batteries which adopt the lithium iron phosphate having improved particle dimensions as a positive-electrode active material. In addition, for a higher energy density and higher output (power), there is developing a nonaqueous electrolyte secondary battery using lithium manganese phosphate which shows a voltage on the order of 4 V as a positive-electrode active material.

### CITATION LIST

### Patent Literature

PTL 1: Japanese Unexamined Patent Application Publication (JP-A) No. H09-134724
PTL 2: Japanese Unexamined Patent Application Publication (JP-A) No. H09-134725
PTL 3: Japanese Unexamined Patent Application Publication (JP-A) No. 2001-85010
PTL 4: Japanese Unexamined Patent Application Publication (JP-A) No. 2001-110414
PTL 5: Japanese Patent No. 3441107

### SUMMARY OF INVENTION

### Problems to be Resolved by the Invention

Accordingly, an object of the present invention is to provide a nonaqueous electrolyte secondary battery having a wider available range of depth of discharge and thereby having a higher energy density.

### Means of Solving the Problems

The present invention provides a nonaqueous electrolyte secondary battery which includes a positive electrode, a negative electrode, and a nonaqueous electrolyte, in which the positive electrode includes a lithium metal phosphate represented by a chemical formula LiMPO₄ (wherein M represents at least one metal element selected from the group consisting of Fe, Mn, Ni, and Co) as a positive-electrode active material; the negative electrode includes a graphite material as a negative-electrode active material; and the negative electrode has an initial charge/discharge efficiency of e2, the positive electrode has an initial charge/discharge efficiency of e1, and e1 and e2 satisfy the relation of formula e2=e1−x (10≦x≦20).

### Advantageous Effect of the Invention

According to the present invention, the secondary battery has a wider available range of depth of discharge and thereby has a higher energy density, because use of the high resistance region of the lithium metal phosphate is avoided to suppress the secondary battery from having an increased resistance.

### BRIEF DESCRIPTION OF DRAWINGS

FIG. 1 is a cross-sectional view illustrating a cylindrical lithium ion secondary battery according to an embodiment of the present invention.

FIG. 2A illustrates an operating principle of a cylindrical lithium ion secondary battery according to Comparative Example 1 and is a graph showing how the potential varies depending on the positive electrode capacity and how the potential varies depending on the negative electrode capacity, respectively, when metallic lithium is used as a counter electrode, in which a positive electrode plate containing a lithium iron phosphate as a positive-electrode active material; and a negative electrode plate containing Graphite A as a negative-electrode active material.

FIG. 2B illustrates an operating principle of the cylindrical lithium ion secondary battery according to Comparative Example 1 and is a graph showing how the cell voltage and discharge resistance vary depending on the depth of charge, concerning a model cell using the positive electrode plate and the negative electrode plate.

FIG. 3A illustrates an operating principle of a cylindrical lithium ion secondary battery according to Example 1 and is a graph showing how the potential varies depending on the positive electrode capacity and how the potential varies depending on the negative electrode capacity, respectively, concerning the lithium ion secondary battery when metallic lithium is used as a counter electrode, in which a positive electrode plate containing a lithium iron phosphate as a positive-electrode active material; and a negative electrode plate containing a mixture of Graphite A and Amorphous Carbon A as a negative-electrode active material.

FIG. 3B illustrates an operating principle of the cylindrical lithium ion secondary battery according to Example 1 and is a graph showing how the cell voltage and the discharge resistance vary depending on the depth of charge, concerning the model cell using the positive electrode plate and the negative electrode plate.

FIG. 4 is a graph showing how the potential varies depending on the discharge capacity of a positive electrode plate containing a lithium iron phosphate as a positive-electrode active material when intermittent discharge is performed using metallic lithium as a counter electrode.

### DESCRIPTION OF EMBODIMENTS

A positive electrode using lithium iron phosphate as a positive-electrode active material (hereinafter referred to as “lithium iron phosphate positive electrode”) tends to have a low capacity density as compared to those using customary lithium compounds such as lithium manganate and lithium cobaltate. In addition, the lithium iron phosphate positive electrode is known to have a higher resistance during the initial and terminal stage of charging/discharging.

These points will be described below.

Lithium iron phosphate shows a discharge capacity of from 150 to 175 mAh/g, which corresponds to 150% of the discharge capacity of lithium manganate (LiMn₂O₄) having a spinel crystal structure, but shows a capacity density equivalent to that of lithium manganate, because the lithium iron phosphate has a lower electrode density by about 50% to about 30% than that of lithium manganate. This is probably because the lithium iron phosphate has a true density of 3.7 g/cm³ smaller than the true density (4.0 to 4.2 g/cm³) of the spinel type lithium manganate. This is also because the lithium iron phosphate positive electrode is controlled to have an electrode density of from 1.7 to 2.0 g/cm³ as the lithium iron phosphate particles are reduced in size so as to have higher reactivity and they are compounded with a carbon material having a further smaller true density so as to obtain higher electrical conductivity, and thereby the positive electrode shows a lower packing density. The capacity density of the lithium iron phosphate as compared to those of lithium cobaltate (LiCoO₂), lithium manganate (LiMn₂O₄), and aluminum/cobalt-substituted lithium nickelate (LiNi_{0.85}Co_{0.10}Al_{0.05}O₂) is shown together in Table 1. The volume of the electrode is adopted herein as the volume used for the determination of the capacity density (mAh/cm³) of the positive electrode.

TABLE 1

| | | Positive | Capacity* per | |
|---|---|---|---|---|
| | | electrode | weight of active | Capacity |
| | | density | material | density |
| Name | Compositional formula | (g/cm³) | (mAh/g) | (mAh/cm³) |
| Lithium iron phosphate | LiFePO₄ | 1.7 | 170 | 246 |
| Lithium manganate | LiMn₂O₄ | 2.6 | 110 | 243 |
| Lithium cobaltate | LiCoO₂ | 3.2 | 155 | 421 |
| Aluminum/cobalt-substituted | LiNi_{0.85}Co_{0.10}Al_{0.05}O₂ | 3.0 | 180 | 459 |
| lithium nickelate | | | | |

*The positive electrode contains 85 percent by weight of the active material, 10 percent by weight of a carbon auxiliary, and 5 percent by weight of PVdF binder.

The capacity was measured at 25° C., the lower and upper limit voltages in charging/discharging for lithium iron phosphate were 2.0 V and 3.6 V, and those for the other materials were 3.0 V and 4.3 V, respectively. The measurement was performed using metallic lithium as a counter electrode, and a 1 M LIPF₆ solution in 1:3 mixture of EC and DMC as an electrolyte.

Table 1 demonstrates as follows. The lithium iron phosphate positive electrode has a capacity density of almost equivalent to, lower than by 30%, and lower than by 40%, respectively, those of already-existing positive electrodes, i.e., positive electrodes of lithium manganate, lithium cobaltate, and aluminum/cobalt-substituted lithium nickelate. The lithium iron phosphate positive electrode fundamentally has a low average potential of 3.4 V and is a material having the lowest energy density among already-existing positive electrodes, specifically, as compared to the lithium manganate positive electrode having an average potential of 3.9 V, the lithium cobaltate positive electrode having an average potential of 3.8 V, and the aluminum/cobalt-substituted lithium nickelate positive electrode having an average potential of 3.7 V. Even when compared to a manganese/cobalt-substituted lithium nickelate (LiNi_{1-x-y}CoₓMn_{y}O₂, wherein 0.30≦x≦0.40, 0.10≦y0.40, and 0.30≦x+y≦0.80; not shown in Table 1), the lithium iron phosphate has a capacity density of lower by 30% to 40% than that of the manganese/cobalt-substituted lithium nickelate, although the latter capacity density varies depending on the nickel content.

The lithium iron phosphate is known to show an increased resistance during the early stage and terminal stage of charging/discharging, due to characteristics of its charge reaction and discharge reaction.

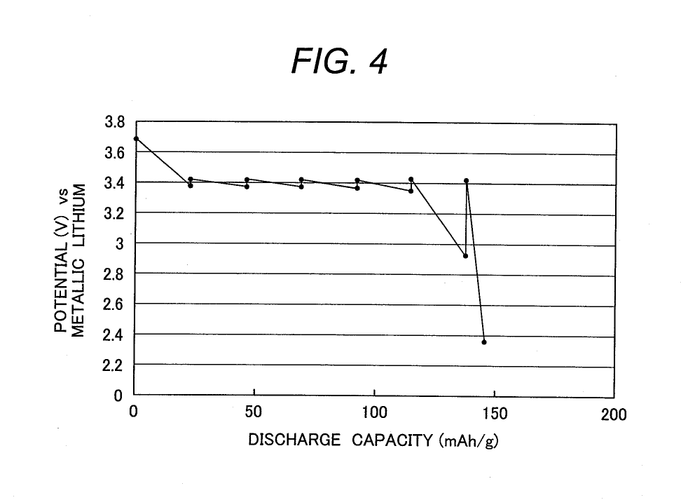

FIG. 4 is a graph showing how the potential varies depending on the discharge capacity of a positive electrode plate containing lithium iron phosphate as a positive-electrode active material when intermittent discharge is performed using metallic lithium as a counter electrode.

FIG. 4 demonstrates as follows. When the lithium iron phosphate (positive electrode) with metallic lithium as a counter electrode is discharged at a given current for a given time, the current is then stooped for a given time, and an open-circuit potential is determined to plot an intermittent discharge curve, the intermittent discharge curve indicates that the resistance increases with an increasing difference between the discharge potential and the open-circuit potential at that point of time. This demonstrates that the lithium iron phosphate positive electrode shows a high resistance immediately after the initiation of discharging, but immediately stably shows a low resistance; it shows a gradually increasing resistance at depths of discharge more than about 75% and has a resistance 10 times as high as that in the early stage of discharging at a depth of discharge of 90%.

For these reasons, an already-existing nonaqueous electrolyte secondary battery using a lithium iron phosphate positive electrode in combination with a negative electrode including a graphite negative-electrode active material shows an increasing resistance at depths of discharge of more than 75% and thereby has a gradually decreasing output. Accordingly, an available (effective) range of depth of discharge is from 5% to 75%, and a total of 30% of the depth of discharge including 5% (depths of discharge of from 0% to less than 5%) and 25% (depths of discharge of more than 75%) is unavailable. In other words, only 70% of the actual battery capacity is available. Accordingly, in a nonaqueous electrolyte secondary battery using a lithium iron phosphate positive electrode, it is important to improve the capacity density to thereby improve the energy density.

The nonaqueous electrolyte secondary battery according to the present invention includes a positive electrode including a positive-electrode active material containing a lithium metal phosphate represented by the chemical formula LiMPO₄ (wherein M represents at least one metal element selected from the group consisting of Fe, Mn, Ni and Co) as a principal component, and has a positive-electrode initial charge/discharge efficiency e1; and a negative electrode including a negative-electrode active material containing a graphite material as a principal component and has a negative-electrode initial charge/discharge efficiency e2, in which e1 and e2 satisfy the relation of formula e2=e1−x (10≦x≦20).

According to the present invention, the positive electrode includes a positive-electrode active material containing a lithium metal phosphate as a principal component and has a positive-electrode initial charge/discharge efficiency e1 and the negative electrode includes a negative-electrode active material containing a graphite material as a principal component and has a negative-electrode initial charge/discharge efficiency e2, in which e1 and e2 satisfy the relation of formula e2=e1−x (10≦x≦20). This configuration broadens the available range of depth of discharge and thereby improves the energy density, because usage of the high-resistance region of the lithium metal phosphate is avoided, and the resistance increase is suppressed.

In this embodiment, the lithium metal phosphate may contain carbon in a content of 1 percent by weight or more and 5 percent by weight or less. The lithium metal phosphate may have a ratio Li/M of lithium Li to the metal element M of from 0.70 or more and 0.80 or less, when the battery is discharged to a battery voltage of 2.0 V. The negative-electrode active material may contain 60 percent by weight or more of a graphite material and 40 percent by weight or less of a carbon material, in which the graphite material may have an interlayer distance d₀₀₂ of 0.3335 nm or more and 0.3375 nm or less as determined through X-ray powder diffractometry and may have a specific surface area of 0.5 m²/g or more and 4 m²/g or less; and the carbon material may be an amorphous carbon or hard carbon (nongraphitizable carbon) having an intensity ratio I_{1360 (D)}/I_{1580 (G)} of an intensity at 1360 (D) cm⁻¹ to an intensity at 1580 (G) cm⁻¹ of 0.8 or more and 1.2 or less as determined through Raman spectrometry and having a specific surface area of 2 m²/g or more and 6 m²/g or less. The negative-electrode active material may contain 80 percent by weight or more of a graphite material and 20 percent by weight or less of a silicon oxide material, in which the graphite material may have an interlayer distance d₀₀₂ of 0.3335 nm or more and 0.3375 nm or less as determined through X-ray powder diffractometry and may have a specific surface area of 0.5 m²/g or more and 4 m²/g or less, and the silicon oxide material may have a specific surface area of 2 m²/g or more and 10 m²/g or less.

As used herein a value range, for example, “0.70 or more and 0.80 or less” means “0.70 or more” and “0.80 or less” and may be expressed as “from 0.70 to 0.80”. Specifically the phrase “0.70 or more and 0.80 or less” refers to a range including values ranging from the lower limit of 0.70 to the upper limit of 0.80 with the lower limit and upper limit inclusive therein.

The present invention gives following advantageous effects. Specifically, the usage of the high-resistance region of the lithium metal phosphate is avoided, and the resistance increase is suppressed, and this broadens the available range of depth of discharge and thereby improves the energy density. This is because the positive electrode includes a positive-electrode active material containing a lithium metal phosphate as a principal component and has a positive-electrode initial charge/discharge efficiency e1; and the negative electrode includes a negative-electrode active material containing a graphite material as a principal component and has a negative-electrode initial charge/discharge efficiency e2, in which e1 and e2 satisfy the relation of formula e2=e1−x (10≦x≦20).

Embodiments of a cylindrical lithium ion secondary battery to which the present invention is adopted will be illustrated below with reference to the attached drawings.

(Structure)

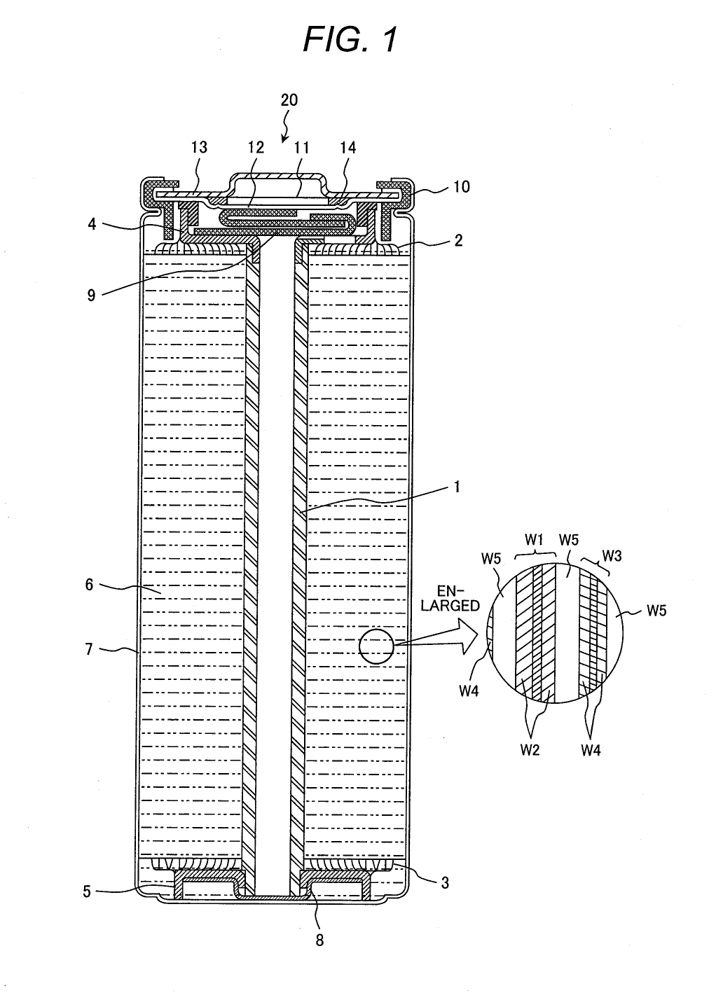

With reference to FIG. 1, a cylindrical lithium ion secondary battery 20 according to this embodiment has a closed-end cylindrical metallic battery case 7. The battery case 7 houses an electrode group 6.

The electrode group 6 includes a strip-shaped positive electrode plate W1 and a strip-shaped negative electrode plate W3 and are arranged with the interposition of a separator W5 so as to avoid the direct contact with each other. These are spirally wound around a resinous hollow cylindrical rod core 1. In this embodiment, the separator W5 is a polyolefin porous film. Positive electrode lead strips 2 drawn from the positive electrode plate W1, and negative electrode lead strips 3 drawn from the negative electrode plate W3 are respectively arranged at the opposite both end faces of the electrode group 6.

A metallic negative electrode collecting ring 5 is arranged below the electrode group 6, for collecting electric potential from the negative electrode plate W3. The inner circumference of the negative electrode collecting ring 5 is fixed to the lower outer circumference of the rod core 1. The outer circumferential edge of the negative electrode collecting ring 5 is joined with each edge of the negative electrode lead strips 3. The bottom of the negative electrode collecting ring 5 is welded with a metallic negative electrode lead plate 8 for electrical conduction, and the negative electrode lead plate 8 is welded with the inner bottom of the battery case 7 through resistance welding, which battery case 7 also serves as a relay terminal for the negative electrode.

Independently, a metallic positive electrode collecting ring 4 is arranged above the electrode group 6 approximately on the extension of the rod core 1. The positive electrode collecting ring 4 serves to collect electric potential (current) from the positive electrode plate W1. The positive electrode collecting ring 4 is fixed to the top end of the rod core 1. Each end portion of the positive electrode lead strips 2 is welded to a peripheral face of a flange portion extended integrally from a periphery of the positive electrode collecting ring 4. The electrode group 6 and the entire circumference of the flange portion of the positive electrode collecting ring 4 are coated with an insulating coating. A battery lid which also serves as a relay terminal for the positive electrode is arranged above the positive electrode collecting ring 4. The battery lid includes a lid case 12, a lid cap 13, a valve guard 14 for maintaining hermeticity, and a cleavage valve (inner gas exhaust valve) 11 which cleaves when the inner pressure increases. The battery lid is assembled by stacking these members, followed by caulking and fixing the circumferential edge of the lid case 12. One end of a positive electrode lead plate 9 is joined to the top of the positive electrode collecting ring 4. The positive electrode lead plate 9 is formed by joining two lead plates each of which is a stack of ribbon-shaped metallic foils. The other end of the positive electrode lead plate 9 is joined to the bottom of the lid case 12 constituting the battery lid.

The battery lid is fixed to an upper portion of the battery case 7 by performing caulking via a gasket 10 so as to fold the positive electrode lead plate 9. The gasket 10 may be composed of a material such as an insulative and heat-resistant resinous material. This allows the inside of the lithium ion secondary battery 20 to be sealed. A nonaqueous electrolyte (not shown) is placed in the battery case 7 so that the entire electrode group 6 is immersible therein. In this embodiment, the nonaqueous electrolyte is a solution of a lithium salt in an organic carbonate solvent.

The positive electrode plate W1 constituting the electrode group 6 includes an aluminum foil as a positive electrode collector. The both sides of the aluminum foil are coated approximately homogeneously and approximately uniformly with a positive-electrode mixture containing a positive-electrode active material capable of intercalating/desorbing lithium ions, thus forming positive-electrode mixture layers W2. In one side edge in a longitudinal direction of the aluminum foil, there is formed a portion without coating of the positive-electrode mixture, namely, a portion from which the aluminum foil is exposed. The exposed portion is notched to form rectangular notches, and the remainder of the notches constitutes two or more positive electrode lead strips 2.

The positive-electrode active material contains lithium iron phosphate (LiFePO₄) as a lithium metal phosphate represented by the chemical formula LiMPO₄ (wherein M represents at least one metal element selected from the group consisting of Fe, Mn, Ni, and Co) as a principal component. In this embodiment, the lithium iron phosphate contains carbon in a content of 1 percent by weight or more and 5 percent by weight or less. Such carbon-hybridized lithium iron phosphate containing carbon may be prepared typically by pulverizing and milling materials such as iron oxalate, lithium carbonate, ammonium phosphate, and dextrin as a carbon source, and firing the mixture in an inert atmosphere at 600° C. to 700° C. for 12 to 24 hours. The firing under such conditions gives a lithium iron phosphate containing carbon. The resulting carbon-hybridized lithium iron phosphate has a primary particle size of about 1 μm and a specific surface area of from 10 to 20 m²/g. In this connection, there are known other synthesis processes of lithium iron phosphate, such as hydrothermal synthesis, sol-gel synthesis, and coprecipitation process; and there are attempts to use other materials such as acetylene black as a carbon source instead of dextrin. Accordingly, the above-mentioned synthesis process of the carbon-hybridized lithium iron phosphate is not intended to limit the lithium iron phosphate as the positive-electrode active material herein.

The positive-electrode mixture may further contain, in addition to the positive-electrode active material, other components such as acetylene black as a conductant agent and a poly (vinylidene fluoride) (hereinafter briefly referred to as PVdF) as a binder (binding agent). Coating of the aluminum foil with the positive-electrode mixture may be performed in the following manner. A dispersion medium such as N-methylpyrrolidone (hereinafter briefly referred to as NMP) is added to and uniformly mixed with the positive-electrode mixture to give a positive-electrode mixture slurry. The prepared slurry is applied to the both sides of the aluminum foil substantially homogeneously and uniformly, is dried, and thereby forms positive-electrode mixture layers W2. The density of the positive-electrode mixture layers W2 is regulated by pressing with a roll pressing machine. The resulting article is cut to a desired size and thereby yields a strip-shaped positive electrode plate W1.

Independently, the negative electrode plate W3 includes a rolled copper foil as a negative electrode collector. The both sides of the rolled copper foil are coated approximately homogeneously and approximately uniformly with a negative-electrode mixture which contains a carbon material as a negative-electrode active material capable of intercalating/desorbing lithium ions to form negative-electrode mixture layers W4. On one side edge in the longitudinal direction of the rolled copper foil, there is formed a portion without coating with the negative-electrode mixture, i.e., a portion from which the rolled copper foil is exposed. The exposed portion is notched to form rectangular notches, and the remainder of the notches constitutes two or more negative electrode lead strips 3.

The negative-electrode active material contains a graphite material as a principal component. The graphite material has a low operating voltage, shows a flat change in voltage, and thereby helps the resulting lithium ion secondary battery to have a higher energy density. Alternatively, an alloy negative electrode using a negative-electrode active material containing silicon or tin as one of constitutive elements thereof also helps the resulting battery to have a higher energy density. Further alternatively, an alloy negative electrode or a negative material of an amorphous carbon material or low-crystallinity carbon material gives a lithium ion secondary battery whose residual capacity can be analyzed relatively easily, because its voltage profile shows a given slope. In this embodiment, the negative electrode specifications are determined additionally in consideration of the relation between capacity and resistance of the lithium iron phosphate positive electrode itself, so as to broaden the available range of depth of discharge to thereby improve the energy density. Specifically, the negative electrode specifications are determined so that the positive-electrode initial charge/discharge efficiency e1 and the negative-electrode initial charge/discharge efficiency e2 satisfy the relation of formula e2=e1−x (10≦x≦20). The charge/discharge efficiencies are values each determined according to the following expression: 100×[(Discharge current)×(Discharge time)]/[(Charge current)×(Charge time)].

The negative-electrode mixture may further contain, in addition to the negative-electrode active material, other components such as PVdF as a binder. The coating of the rolled copper foil with the negative-electrode mixture may be performed in the following manner. A dispersion medium such as NMP is added to the negative-electrode mixture to give a negative-electrode mixture slurry. The prepared slurry is substantially uniformly and homogeneously applied to the both sides of the rolled copper foil to a given thickness, is dried, and thereby forms negative-electrode mixture layers W4. The density of the negative-electrode mixture layers W4 is regulated by pressing with a roll pressing machine. The resulting article is cut to a desired size and thereby yields a strip-shaped negative electrode plate W3.

Next, a combination of a positive electrode plate W1 and a negative electrode plate W3 will be described from the viewpoints of broadening the available range of depth of discharge and thereby improving the energy density. In other words, the available capacity, charge/discharge curve profile, and resistance of the battery are determined by the combination of the positive electrode plate W1 and the negative electrode plate W3. An operating principle using lithium iron phosphate alone and Graphite A (described in detail later) alone as the positive-electrode active material and the negative-electrode active material will be described below, respectively.

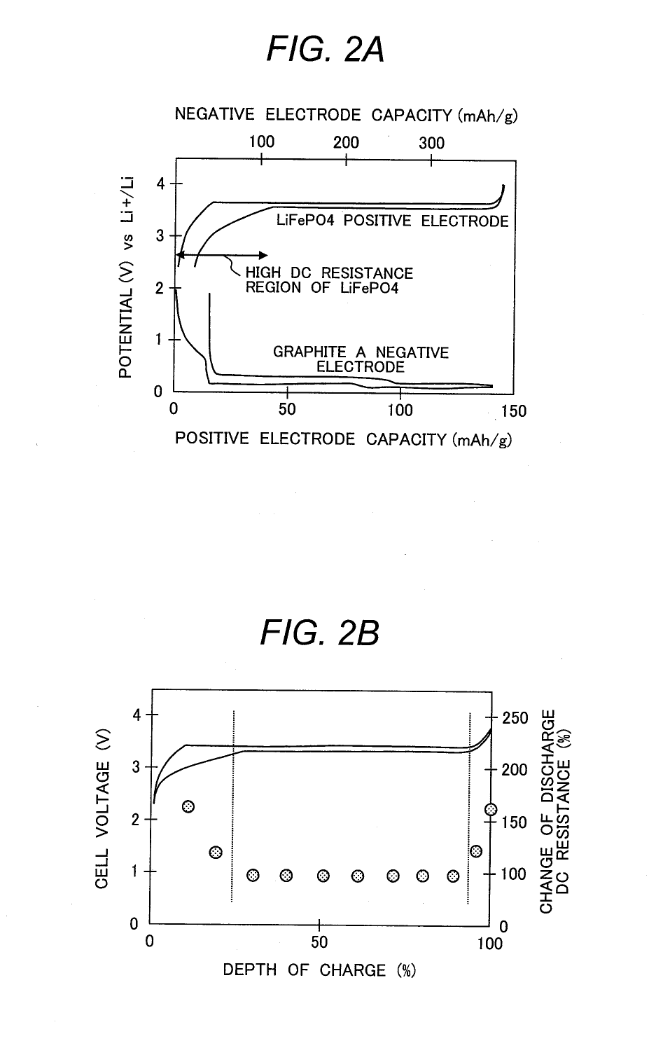

FIGS. 2A and 2B illustrate an operating principle of a cylindrical lithium ion secondary battery according to Comparative Example 1. FIG. 2A is a graph showing how the potential varies depending on the positive electrode capacity and how the potential varies depending on the negative electrode capacity when metallic lithium is used as a counter electrode, concerning a positive electrode plate containing lithium iron phosphate as a positive-electrode active material, and a negative electrode plate containing Graphite A as a negative-electrode active material; and FIG. 2B is a graph showing how the cell voltage and discharge resistance vary depending on the depth of charge, concerning a model cell using the positive electrode plate and the negative electrode plate.

As is demonstrated in FIGS. 2A and 2B, the battery capacity is determined by the weights of active materials and ratios thereof of the positive and negative electrodes and by the initial charge/discharge efficiencies of the positive and negative electrodes. Typically, when the battery is used approximately to the charge/discharge limitations of the respective positive and negative-electrode materials for higher capacity, the lithium iron phosphate positive electrode shows a charge capacity of 140 mAh/g or more and 170 mAh/g or less, and the graphite negative electrode shows a charge capacity of 320 mAh/g or more and 400 mAh/g or less. The sample of FIG. 2A has a positive electrode charge capacity of 145 mAh/g and a negative electrode charge capacity of 370 mAh/g. The positive electrode using lithium iron phosphate shows a high positive-electrode initial charge/discharge efficiency e1 of 97% or more and 99% or less, because the lithium iron phosphate has a low charge upper limit voltage of 3.6 V due to its reversibility and does not cause the organic electrolyte to decompose. In contrast, the graphite negative electrode shows a negative-electrode initial charge/discharge efficiency e2 of 90% or more and 95% or less, because part of the electrolyte component decomposes on the graphite surface, while this varies depending on the specifications. There is known a technique of forming a solid electrolyte layer at the interface between solid and liquid phases to thereby suppress the decomposition of the electrolyte component and to ensure the reversibility of the graphite negative electrode. The sample of FIG. 2A has a positive-electrode initial charge/discharge efficiency e1 of 98% and a negative-electrode initial charge/discharge efficiency e2 of 92%.

The charge capacities and initial charge/discharge efficiencies are values determined on a bipolar model cell using metallic lithium as a counter electrode. FIG. 2A also shows how the resistance varies depending on the discharge capacity. The resistance values are values as determined from the change of voltage at varying currents of 0.5, 1, and 3 CA. Based on this, how the resistance varies depending on the discharge capacity relative to the resistance at a depth of discharge of 50% is determined.

The resistance of the lithium iron phosphate positive electrode gradually increases at a discharge capacity of 100 mAh/g or more, becomes 140% at a discharge capacity of 120 mAh/g, and reaches 200% at a discharge capacity of 140 mAh/g. In contrast, the resistance of the graphite negative electrode little changes and remains at 100% at discharge capacities of from 0 to 320 mAh/g, thereafter sharply increases, and reaches 200% at a discharge capacity of 340 mAh/g corresponding to 100% discharge.

The discharge capacity of the lithium ion secondary battery using the lithium iron phosphate positive electrode and the graphite negative electrode is limited by the capacity of the graphite negative electrode which has a lower initial charge/discharge efficiency. When the graph of FIG. 2A is rewritten with the abscissa indicating the depth of discharge of the battery, the resistance gradually increases at depths of discharge of more than 75%, as illustrated in FIG. 2B. FIG. 2B shows how the resistance varies relative to the resistance at a depth of discharge of 50%. The change of the resistance at depths of discharge of 75% or more is derived from the resistance increase in the latter half of discharging of the lithium iron phosphate positive electrode.

For these reasons, such regular lithium ion secondary battery using a lithium iron phosphate positive electrode and a graphite negative electrode as illustrated in FIGS. 2A and 2B is actually available for charge/discharge only at depths of discharge of from 5% to 75%, within which the resistance varies little. This is because the secondary battery fails to give a sufficient output at a high resistance. Typically, in a 18650 battery having a capacity of 800 mAh, only a capacity of 560 mAh is available, which corresponds to 70% of the total capacity. Specifically, a total of 30% of the depth of discharge including 5% (depths of discharge of from 0% to less than 5%) and 25% (depths of discharge of more than 75%) is unavailable.

The present inventors made intensive investigations on the specifications of electrodes and battery, and reaction mechanisms thereof, while considering that the available capacity and energy density may be improved by suppressing the resistance change at depths of discharge of 75% or more and thereby broadening the available range of depth of discharge in the use of a lithium iron phosphate positive electrode. As a result, they have found that the resistance change of the battery may be controlled by controlling the initial charge/discharge efficiency of the negative electrode, resulting in a wider available range of capacity and a higher energy density.

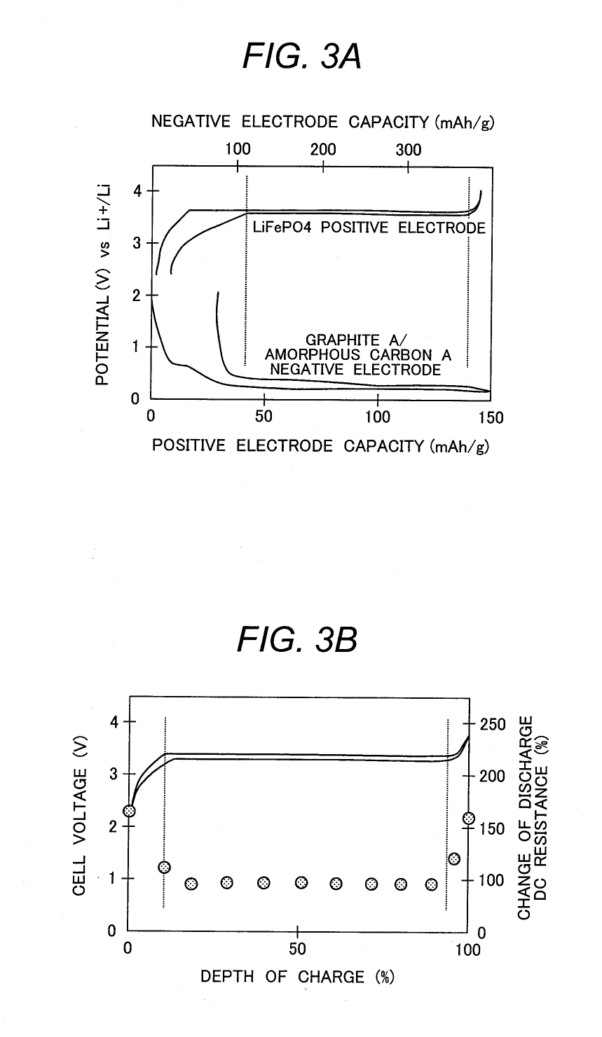

FIGS. 3A and 3B illustrate an operating principle of a cylindrical lithium ion secondary battery according to Example 1. FIG. 3A is a graph showing how the potential varies depending on the positive electrode capacity and how the potential varies depending on the negative electrode capacity when metallic lithium is used as a counter electrode, concerning a positive electrode plate containing lithium iron phosphate as a positive-electrode active material; and a negative electrode plate containing a mixture of Graphite A and Amorphous Carbon A as a negative-electrode active material. FIG. 3B is a graph showing how the cell voltage and the discharge resistance vary depending on the depth of charge, concerning a model cell using the positive electrode plate and the negative electrode plate.

With reference to FIGS. 3A and 3b, this working example employs a positive electrode having the same specifications as those of the positive electrode used in FIGS. 2A and 2B (Comparative Example 1), but uses a negative electrode having different specifications to restrict the usage at discharge capacities of 100 mAh/g or more where the resistance of the positive electrode increases. Specifically, the negative electrode herein is a mixture of 60:40 by weight ratio of Graphite A having the same specifications as those of the negative-electrode active material used in FIGS. 2A and 2B (Comparative Example 1) and Amorphous Carbon A (described in detail later). Amorphous Carbon A used herein has a charge capacity of 450 mAh/g and a discharge capacity of 350 mAh/g when metallic lithium is used as a counter electrode. The usage of the range where the resistance of the lithium iron phosphate positive electrode increases is restricted by specifying the mixed negative electrode containing a mixture of Graphite A and Amorphous Carbon A to have a charge capacity of 402 mAh/g, a discharge capacity of 344 mAh/g, and a negative-electrode initial charge/discharge efficiency (e2) of 85%.

With reference to FIG. 3B, a mixture of Graphite A and Amorphous Carbon A used as a negative electrode suppresses the discharge capacity of the negative electrode alone and the resistance increase at depths of discharge of 75% or more, resulting in a wider available range of depth of discharge of from 5% to 90%. Specifically, the available range of depth of discharge reaches 85% of the total capacity, and the lithium ion secondary battery is capable of discharging more than the battery using the Graphite A negative electrode and having the specifications illustrated in FIGS. 2A and 2B, by 15% in terms of depth of discharge. Typically, a 18650 battery having a capacity of 800 mAh shows an available range of capacity of 560 mAh when using the Graphite A negative electrode. In contrast, the battery according to this embodiment shows a higher available capacity of 680 mAh than that of the 18650 battery by about 20% by using the mixed negative electrode.

The graphite material and amorphous carbon material used as negative-electrode active materials will be described below. The negative-electrode active material preferably contains a graphite material as a principal component. Specifically, the negative-electrode active material preferably contains a graphite material in a content of 60 percent by weight or more. By using a graphite material as a principal component of the negative-electrode active material, the voltage less changes and the resistance less increases during discharging, and this allows the present invention to be carried out effectively. Such a graphite material has an interlayer distance d₀₀₂ of from 3.335 to 3.375 angstroms (0.3335 to 0.3375 nm) as determined through X-ray powder diffractometry, an average particle size of from 10 to 20 μm, and a specific surface area of from 0.5 to 4 m²/g. A graphite material having an interlayer distance d₀₀₂ of less than 3.335 angstroms or of more than 3.375 angstroms may cause the secondary battery to show a significantly low charge/discharge capacity, thus being undesirable. A graphite material having a specific surface area of less than 0.5 m²/g may show poor reactivity, thus being undesirable.

Exemplary negative-electrode active materials usable as secondary components in addition to the principal component graphite material include amorphous carbon, low-crystallinity carbon (hard carbon or nongraphitizable carbon), and silicon or tin alloy materials. Of such amorphous carbons and low-crystallinity carbons, preferred are those having a ratio (I_{1360 (D)}/I_{1580 (G)}) of the intensity at 1360 (D) cm⁻¹ to the intensity at 1580 (G) cm⁻¹ of 0.8 or more and 1.2 or less as determined through Raman spectrometry, having an average particle diameter of from 5 to 15 μm, and having a specific surface area of 2 m²/g or more and 6 m²/g or less. In the analysis of a carbon material through Raman spectrometry, there are observed a Raman peak at 1360 cm⁻¹ called D band, and a Raman peak at 1580 cm⁻¹ called G band. Based on the ratio in intensity between the two peaks, the degree of graphitization and orientation of the carbon material can be evaluated. Such amorphous carbon material is preferably used in a content of 40 percent by weight or less in the negative-electrode active material when it is employed as a secondary component.

A negative-electrode active material using an amorphous carbon or low-crystallinity carbon as a principal component instead of the graphite material may show gradual decrease of voltage and gradual increase of resistance upon discharging and may be difficult to maintain a constant output, thus being undesirable. Of silicon alloys and compounds and of tin alloys, SiO and SnCo alloys are preferred. However, the negative-electrode active material using these as a principal component may show insufficient reversibility in charge/discharge and may cause the battery to have a low voltage, thus being undesirable.

As has been described above, the present inventors have found that the lithium iron phosphate positive electrode has a positive-electrode initial charge/discharge efficiency e1 of 97% to 99% and shows a resistance significantly increasing at depths of discharge of 75% or more, and therefore the resistance increase derived from the positive electrode can be reduced in the battery as a whole by controlling the negative electrode not to utilize the positive-electrode initial charge/discharge efficiency e1 by 10% to 20%. Specifically, the present inventors have found that a lithium ion secondary battery which shows a small resistance change (increase) and maintains a constant output at depths of discharge in a wide range is obtained by using a negative electrode having a negative-electrode initial charge/discharge efficiency e2 of 77% or more and 87% or less. It is not always necessary to use a mixture of a graphite material and an amorphous carbon material as a negative-electrode active material. Typically, the negative-electrode active material may include graphite particles whose surfaces are coated with an amorphous carbon material or may include composite particles of graphite particles and amorphous carbon particles. Independently, the negative-electrode active material may employ a substance having a low initial charge/discharge efficiency, as in a silicon or tin alloy negative electrode. However, this negative-electrode active material may show low reversibility in charge/discharge and may cause the battery to have a low voltage when used in combination with the lithium iron phosphate positive electrode. In consideration of these, a negative-electrode active material containing a mixture of a graphite material and an amorphous carbon material so as to have a negative-electrode initial charge/discharge efficiency (e2) within the above range is more effective.

Intensive investigations have been made to improve the resistance increase of a lithium iron phosphate positive electrode at depths of discharge of 75% or more. Exemplary techniques for this purpose include fine adjustment of the compositional ratio of Li/Fe, substitution with a dissimilar metal such as molybdenum, and allowing primary particles to be finer. However, significant improvements are not expected according to these techniques, because the resistance increase in the latter half of discharging is derived from that an insertion reaction of lithium ions into iron phosphate proceeds in a two-phase reaction system between LiFePO₄ phase and FePO₄ phase with a large difference in lattice size between them. Independently, the lithium iron phosphate positive electrode shows, upon discharging, a decreasing reaction rate and thereby an increasing resistance as the Li/Fe ratio (ratio of Li to Fe) in crystals approaching 1. To avoid this, the lithium iron phosphate preferably has a ratio Li/Fe of from 0.70 to 0.80 when the battery is discharged to a battery voltage of 2.0 V. The technique of allowing primary particles to have finer (smaller) sizes is contradictory to the improvement of capacity, because this technique increases the amount of composited carbon and thereby reduces the packing density, i.e., reduces the electrode density.

A possible solution to allow a graphite negative electrode to have a negative-electrode initial charge/discharge efficiency of 77% or more and 87% or less is a technique of adding a component which will irreversibly decompose on the negative electrode to a nonaqueous electrolyte. This technique, however, has disadvantages such that the component generates a gas upon decomposition to increase the battery inner pressure and that the component is inactivated on the surface of the negative electrode, thus being undesirable.

Accordingly, a battery system using lithium iron phosphate in a positive electrode can less suffer from resistance increase in a wide range of depths of discharge and can give a constant output by not using the region where the resistance of the lithium iron phosphate increases upon discharging, while allowing the negative electrode to have a higher charge capacity, and allowing the negative electrode to have a negative-electrode initial charge/discharge efficiency e2 satisfying the formula e2=e1−x (wherein e1 represents the positive-electrode initial charge/discharge efficiency, and 10≦x≦20).

(Operation and Others)

Next, the operations and others of the lithium ion secondary battery 20 according to this embodiment will be described below.

Customary lithium ion secondary batteries representing nonaqueous electrolyte secondary batteries have mostly employed lithium cobaltate as a positive-electrode active material. However, the use of lithium cobaltate increases the production cost of batteries, because material cobalt is produced in a small quantity and is expensive.

Batteries using lithium manganate instead of lithium cobaltate have problems such that they are difficult to give sufficient discharge capacities and often suffer from dissolution out of manganese in high-temperature surroundings. Batteries using lithium nickelate instead of lithium cobaltate have problems such that they show low discharge voltages and are poorly thermally stable during the terminal stage of charging.

In contrast, lithium iron phosphate and other lithium metal phosphates having an olivine crystal structure and represented by General Formula LiMPO₄ (wherein M represents at least one metal element selected from the group consisting of Co, Ni, Mn and Fe) have such battery voltages as to be arbitrarily set according to the type of the constitutive metal element M. In addition, these lithium metal phosphates have relatively high theoretical capacities, thereby have large battery capacities per unit mass, and excel in thermal stability owing to their structures. Of these lithium metal phosphates, lithium iron phosphate shows poor electron conductivity, because a localized electron structure is formed due to the presence of PO₄ serving as a polyanion. In addition, lithium iron phosphate shows poor diffusibility of lithium ions, because the diffusion of lithium ions therein is limited due to its rigid crystal structure and occurs only in a one-dimensional diffusion path. For these reasons, lithium iron phosphate is likely to have a lower capacity density and to show an increased resistance during the early stage and terminal stage of charging/discharging, as compared to customarily used lithium manganate and lithium cobaltate. Accordingly, if the suppression of resistance increase during the terminal stage of discharging can achieve when lithium iron phosphate is used as a positive-electrode active material, it is expected to give a lithium ion secondary battery which shows a stable output in a wide range of capacity while maintaining satisfactory thermal stability. The lithium ion secondary battery according to this embodiment is one that can solve these problems.

As has been described above, lithium iron phosphate shows a decreasing reaction rate with a ratio of the lithium amount to the iron amount in crystals approaching 1, during discharging where lithium ions are desorbed and intercalated. This is because the diffusion path of lithium ions in lithium iron phosphate is one-dimensional. For this reason, a customary lithium ion secondary battery using lithium iron phosphate as a positive-electrode active material shows an increasing resistance and a decreasing output at depths of discharge of 75% or more. In contrast, the lithium ion secondary battery 20 according to this embodiment employs a positive electrode plate W1 using a positive-electrode active material containing lithium iron phosphate as a principal component; and a negative electrode plate W3 using a negative-electrode active material containing a graphite material as a principal component. The specifications of the battery are determined so that the positive electrode has a positive-electrode initial charge/discharge efficiency of e1, the negative electrode has a negative-electrode initial charge/discharge efficiency of e2, and e1 and e2 satisfy the formula e2=e1−x (10≦x≦20). This avoids the usage of the region where the positive electrode using lithium iron phosphate as a positive-electrode active material shows a high resistance, and the resulting battery can have a wider available range of depth of discharge, in which resistance increase is suppressed, and can have a higher energy density.

According to this embodiment, the lithium iron phosphate used in a positive-electrode active material may contain carbon in a content of 1 percent by weight or more and 5 percent by weight or less. The presence of a highly-electron-conductive carbon material in the lithium iron phosphate having poor electron conductivity enables the lithium iron phosphate to exhibit more satisfactory electron conductivity. This helps the positive electrode to less increase in resistance and thereby helps the battery to give a higher output.

Additionally, the lithium ion secondary battery 20 according to this embodiment has a ratio Li/Fe of lithium Li to iron Fe in the lithium iron phosphate of 0.70 or more and 0.80 or less when the battery is discharged to a discharge cut-off voltage of 2.0 V. The lithium iron phosphate shows a decreasing reaction rate with the ratio of the lithium amount to the iron amount in crystals approaching 1 upon intercalation of lithium ions, as described above. The lithium iron phosphate decreases less in reaction rate when it has a ratio Li/Fe of 0.70 to 0.80. Thereby, it less increases in resistance and helps the battery to give a higher output.

In this embodiment, in addition, the negative-electrode active material includes 60 percent by weight or more of a graphite material and 40 percent by weight or less of an amorphous carbon material and thereby employs the graphite material as a principal component of the negative-electrode active material. A negative electrode shows a sharply increasing resistance of itself during the terminal stage of discharging if it uses a graphite material alone as the negative-electrode material, and this may cause the battery to have a lower output as a whole, even when the resistance increase of the positive electrode is suppressed. In contrast, a negative electrode shows a gradually decreasing voltage and a gradually increasing resistance upon discharging if it uses an amorphous carbon material as a principal component of the negative-electrode active material, and this makes it difficult to maintain a constant output. For these reasons, the battery shows less change in voltage and less increase in resistance during discharging by using 60 percent by weight or more of a graphite material as a principal component and 40 percent by weight or less of an amorphous carbon material as a secondary component in the negative-electrode active material.

The graphite material used as a negative-electrode active material is preferably a material having an interlayer distance d₀₀₂ of from 3.335 to 3.375 angstroms (0.3335 to 0.3375 nm) as determined through X-ray powder diffractometry, an average particle size of from 10 to 20 μm, and a specific surface area of from 0.5 to 4 m²/g. A graphite material having an interlayer distance d₀₀₂ of less than 3.335 angstroms or of more than 3.375 angstroms may show a remarkably low charge/discharge capacity. A graphite material having a specific surface area of less than 0.5 m²/g may have poor reactivity. To avoid these, the use of a graphite material having an interlayer distance d₀₀₂, an average particle size, and a specific surface area respectively within the above-specified ranges helps the battery to have a satisfactory charge/discharge capacity and to exhibit satisfactory reactivity. Independently, the amorphous carbon material used as a secondary component of the negative-electrode active material is preferably a material having an intensity ratio (I_{1360 (D)}/I_{1580 (G)}) of the intensity at 1360 (D) cm⁻¹ to the intensity at 1580 (G) cm⁻¹ of 0.8 or more and 1.2 or less as determined through Raman spectrometry, an average particle diameter of from 5 to 15 μm, and a specific surface area of 2 m²/g or more and 6 m²/g or less. An amorphous carbon material having this configuration used in the negative-electrode active material helps the resulting lithium ion secondary battery to have a residual capacity to be easily analyzed, because the voltage profile thereof has a given slope.

In this embodiment, lithium iron phosphate is used as an example of the positive-electrode active material. However, the positive-electrode active material for use in the present invention is not limited thereto, as long as using a lithium metal phosphate represented by the chemical formula LiMPO₄ (wherein M represents at least one metal element selected from the group consisting of Fe, Mn, Ni and Co) as a principal component thereof. As a positive-electrode active material instead of lithium iron phosphate, it is possible to use lithium magnesium phosphate, lithium cobalt phosphate, or another compound which has the same crystal structure and shows the same reaction mechanism as with those of lithium iron phosphate. It is also possible to additionally use a material capable of intercalating/desorbing lithium ions, as a mixture with lithium iron phosphate. These materials used in the positive-electrode active material helps the battery to have a higher battery voltage and to have a higher output and higher energy density synergistically with effects of the combination of the specific positive electrode with the specific negative electrode.

In this embodiment, the negative-electrode active material as exemplified is one using a graphite material as a principal component and an amorphous carbon material as a secondary component, but this example is not intended to limit the scope of the present invention. Exemplary secondary components of the negative-electrode active material usable herein include low-crystallinity carbon materials and hard carbon materials, in addition to amorphous carbon materials, and the use of silicon or tin alloys is also possible. The negative electrode being a synthetic negative electrode containing silicon and/or tin as one of constitutive elements helps the resulting lithium ion secondary battery to have a higher energy density. Silicon oxide (SiO) and a tin-cobalt (SnCo) alloy are preferably used as such silicon alloys and compounds and tin alloys. However if these components used as a principal component, they cause the battery to show inferior reversibility in charge/discharge and to have a lower battery voltage, thus being undesirable. When a silicon oxide material is used as a secondary component of the negative-electrode active material, the negative-electrode active material preferably contains the secondary component in a content of 20 percent by weight or less; and a graphite material as a principal component in a content of 80 percent by weight or more as a mixture with each other. The silicon oxide material herein preferably has a specific surface area of from 2 to 10 m²/g. A silicon oxide material may have an insufficient reaction area if it has an excessively small specific surface area. In contrast, a silicon oxide material may have excessively small particle sizes, thus being undesirable in handling if it has an excessively large specific surface area.

In this embodiment, the exemplified battery uses PVdF as a binder in the formation of a positive-electrode mixture layer W2 and a negative-electrode mixture layer W4, but this example is not intended to limit the scope of the present invention. Typically, a mixture of two or more PVdFs having different molecular weights may be used for helping the electrodes to have satisfactory adhesiveness. When a material having a high specific surface area is used as a positive-electrode active material or negative-electrode active material, carboxymethylcellulose (CMC) and/or styrene-butadiene rubber (SBR) with water as a solvent (medium) may be used as a binder, because the material requires adhesiveness between particles and adhesiveness with an aluminum foil serving as a positive electrode collector or with a rolled copper foil serving as a negative electrode collector. However, such an aqueous binder is not preferred when lithium iron phosphate is used as a positive-electrode active material, because lithium iron phosphate has a small particle size and a high specific surface area and thereby requires higher adhesiveness, but the active material surface is inactivated by the reaction between lithium iron phosphate and water.

The exemplified nonaqueous electrolyte in this embodiment is a solution of a lithium salt in an organic carbonate solvent, but this example is not intended to limit the scope of the present invention. Typically, exemplary electrolytes for use herein include lithium salts such as CF₃SO₃Li, C₄F₉SO₈Li, (CF₃SO₂)₂NLi, (CF₃SO₂)₃CLi, LiBF₄, LiPF₆, LiClO₄, and LiC₄O₈B. A solvent for dissolving these electrolytes therein is preferably a nonaqueous solvent. Exemplary nonaqueous solvents include chain carbonates, cyclic carbonates, cyclic esters, nitrile compounds, acid anhydrides, amide compounds, phosphate compounds, and amine compounds. Specific examples of such nonaqueous solvents include ethylene carbonate, diethyl carbonate (DEC), propylene carbonate, dimethoxyethane, γ-butyrolactone, n-methylpyrrolidinone, N,N′-dimethylacetamide, and acetonitrile. Mixtures of these solvents, such as a mixture of propylene carbonate and dimethoxyethane, and a mixture of sulfolane and tetrahydrofuran, are also usable herein. An electrolyte layer to be held between the positive electrode plate W1 and the negative electrode plate W3 may be an electrolyte solution containing any of the electrolytes in a nonaqueous solvent or may be a polymer gel containing the electrolyte solution (polymer-gel electrolyte).

The secondary battery according to this embodiment illustratively employs constitutive materials typically for the separator W5 and the battery case 7, and other components, but these exemplified materials are not intended to limit the scope of the present invention, and any known materials may be used herein. For example, the separator W5 is generally composed of a polyolefin porous film, but may also be composed of a composite film typically of a polyethylene and a polypropylene. Alternatively, the separator may be a ceramic composite separator coated with a ceramic such as alumina on its surface, or a ceramic composite separator composed of a porous film including a ceramic as a part of its constitutive materials as the separator requires thermal stability. The use of such a highly thermally stable ceramic composite separator in combination with a positive electrode using lithium iron phosphate as a principal component of the positive-electrode active material is expected to give a lithium ion secondary battery having further better thermal stability, because the lithium iron phosphate used as the principal component shows somewhat poor oxygen supply capability at elevated temperatures in the state of charge due to its olivine crystal structure, and this causes less heat of the reaction with the nonaqueous electrolyte.

The cylindrical lithium ion secondary battery 20 as exemplified in this embodiment includes the closed-end cylindrical battery case 7 housing the electrode group 6, in which the battery case 7 is sealed with the battery lid. However, the battery shape and battery structure are not limited in the present invention. Typically, the battery may be in the form of a rectangular or polygonal, or an oblate cylindrical, instead of being cylindrical. Instead of the electrode group 6 including positive and negative electrode plates as being spirally wound, positive and negative electrode plates may be stacked to form a electrode group.

### EXAMPLES

Hereinafter the lithium ion secondary battery 20 according to this embodiment will be illustrated in detail with reference to working examples below, together with lithium ion secondary batteries according to comparative examples as prepared for comparison.

### Example 1

### Mixture of Graphite A and Amorphous Carbon A

In Example 1, a carbon-hybridized lithium iron phosphate

(LiFePO₄) as a positive-electrode active material was prepared in the following manner. Specifically, iron oxalate (FeC₂O₄.2H₂O; supplied by Kanto Chemical Co., Inc.), lithium carbonate (Li₂CO₃; supplied by Kanto Chemical Co., Inc.), ammonium dihydrogen phosphate (NH₄H₂PO₄; supplied by Kanto Chemical Co., Inc.), and dextrin (supplied by Kanto Chemical Co., Inc.) as a carbon source were pulverized and mixed in a satellite ball mill for 2 hours, the mixture was fired in an argon gas atmosphere at 600° C. for 24 hours, and thereby synthetically yielded a lithium iron phosphate containing 5 percent by weight of carbon. The resulting carbon-hybridized lithium iron phosphate was subjected to X-ray powder diffractometry to verify the absence of heterogenous phases.

The X-ray powder diffractometry was performed with the RINT 2000 supplied by Rigaku Corporation using the Cu Kα1 line monochromatically obtained through a graphite monochromator from Cu Kα lines as a radiation source. The measurement was performed under conditions of a tube voltage of 48 kV, a tube current of 40 mA, scanning field of 15°≦2θ≦80°, a scanning speed of 1.0°/min, a sampling interval of 0.02°/step, a divergence slit of 0.5°, a scattering slit of 0.5°, and a receiving slit of 0.15 mm. Next, the specific surface area of the carbon-hybridized lithium iron phosphate was measured with the Macsorb HM-1200 supplied by Mountech Co., Ltd. (BET 5-point). Next, a slurry was prepared by mixing 85 percent by weight of the above-obtained carbon-hybridized lithium iron phosphate having a specific surface area of 15 m²/g and 5 percent by weight of acetylene black with a solution of a PVdF (KF Polymer #1120; supplied by Kureha Corporation) in NMP. The slurry was applied to an aluminum foil in a mass of coating of 13 mg/cm², dried at 80° C. for 1 hour, regulated to have an electrode density of 1.6 g/cm³, further dried at 120° C. under reduced pressure for 12 hours, and thereby yielded a positive electrode plate W3. The positive electrode plate W3 was charged to 3.6 V at 1.0 mA/cm² until the current converged at 0.01 mA/cm², and then discharged to 2.0 V at 1.0 mA/cm². In this process, the positive electrode showed a charge capacity of 145 mAh/g and a discharge capacity of 143.5 mAh/g per unit weight of the positive-electrode active material (LiFePO₄).

A mixture of Graphite A and Amorphous Carbon A was used as a negative-electrode active material. Graphite A showed an interlayer distance d₀₀₂ of 3.358 angstroms as determined through X-ray powder diffractometry and a specific surface area of 1.5 m²/g and had a charge capacity of 370 mAh/g (The charging was performed to 0.05 V at 1.0 mA/cm², in which the current converged at 0.01 mA/cm²) and a discharge capacity of 340 mAh/g (initial charge/discharge efficiency: 92%, whereas the discharging was performed to 1 V at 1.0 mA/cm²). Amorphous Carbon A showed an intensity ratio I_{1360 (D)}/I_{1580 (G)} of 1.1 and a specific surface area of 5 m²/g and had a charge capacity of 450 mAh/g and a discharge capacity of 350 mAh/g (initial charge/discharge efficiency: 78%). The intensity ratio herein was determined through Raman spectrometry with the Raman Spectrophotometer NRS-2100 supplied by JASCO Corporation, using a 514.5-nm Ar laser as a light source at a laser intensity of 100 mW. A 60:40 (by weight) mixture of Graphite A and Amorphous Carbon A was used as the negative-electrode active material. Next, a slurry was prepared by blending 93 percent by weight of the negative-electrode active material and 7 percent by weight of PVdF (KF Polymer #9305: supplied by Kureha Corporation) and suspending the mixture in NMP. The slurry was applied to a rolled copper foil in a mass of coating of 4 mg/cm². The charge capacity herein should fall in the range of 70% to 100% of the initial negative electrode charge capacity and is preferably small within this range, from the viewpoint of charge/discharge cycle life. However, the ratio in mass of coating between the positive and negative-electrode mixtures was set in this example so that the charge capacity be 100%. The masses of coating of the positive and negative-electrode mixtures were controlled such that the positive electrode have a charge capacity of 145 mAh/g (per gram of the active material) and the negative electrode have a charge capacity of 400 mAh/g (per gram of the active material). The negative electrode having the specifications had an initial charge capacity of 402 mAh/g, a negative-electrode initial charge/discharge efficiency (e2) of 86%, and a difference x between the positive-electrode initial charge/discharge efficiency e1 and the negative-electrode initial charge/discharge efficiency e2 of 13%. The negative electrode specifications are collectively shown in Table 2.

TABLE 2

| | | Weight ratio in | Initial | Initial | |
|---|---|---|---|---|---|
| | | negative- | charge | charge/discharge | |
| | Negative electrode | electrode active | capacity | efficiency: e2 | x |
| | specifications | material | (mAh/g) | (%) | (=e1* −e2) |
| Example 1 | Graphite A/Amorphous | 60/40 | 402 | 86 | 13 |
| | Carbon A | | | | |
| Example 2 | Graphite A/Amorphous | 60/40 | 344 | 87 | 12 |
| | Carbon B | | | | |
| Example 3 | Graphite B/Amorphous | 65/35 | 344 | 89 | 10 |
| | Carbon B | | | | |
| Example 4 | Graphite A/SiO | 80/20 | 702 | 81 | 18 |
| Com. Ex. 1 | Graphite A | 100 | 370 | 92 | 7 |
| Com. Ex. 2 | Graphite B | 100 | 340 | 94 | 5 |
| Com. Ex. 3 | Amorphous Carbon A | 100 | 450 | 77 | 22 |
| Com. Ex. 4 | Amorphous Carbon B | 100 | 350 | 80 | 19 |

*e1 represents the initial charge/discharge efficiency of lithium iron phosphate positive electrode and is 99%.

A bipolar model cell was prepared using the positive electrode plate W1 containing the carbon-hybridized lithium iron phosphate as a positive-electrode active material; the negative electrode plate W3 containing a mixture of Carbon A and Amorphous Carbon A as a negative-electrode active material; and a separator W5 (polyolefin separator UP3146 supplied by Ube Industries, Ltd.). A solution of 1 M LiPF₆ in 1:3 mixture of EC and EMC was used as a nonaqueous electrolyte. The model cell was charged at room temperature at a current of 1.0 mA/cm² and an upper limit voltage of 3.6 V to an end current of 0.1 mA/cm². The model cell was then discharged at a current of 1.0 mA/cm² to 2.0 V. A capacity at that time point was defined as a depth of discharge of 100%, whereas a capacity upon another charge under the same conditions was defined as a depth of charge [=100−(depth of discharge)] of 100%. The cell was discharged at 5% intervals in terms of depth of charge, left stand for 1 hour to show an open-circuit voltage, subjected to a pulsed discharge of 1 CA, 2 CA, and 3 CA at room temperature, and, every 5 seconds, a direct-current resistance was determined through collinear approximation using a closed-circuit voltage.

Next, relative values of direct-current resistance were determined while defining the direct-current resistance at a depth of discharge of 50% to be 100, and how the direct-current resistance varies depending on the depth of discharge was determined. As a result, the direct-current resistance decreased immediately after the initiation of discharging and then became stable with a change of 10% or less during discharging to a depth of charge of 85%. When the cell was further discharged, it showed an abruptly increased resistance, which reached 130%. An available range of depth of discharge where the change of the direct-current resistance is 10% or less (hereinafter also referred to as “available range of discharge depth”) is shown in Table 3.

TABLE 3

| | | | Available range of discharge |
|---|---|---|---|
| | | x | depth (%) with resistance |
| | Negative electrode specifications | (=e1*¹ −e2*²) | increase of 10% or less*³ |
| Example 1 | Graphite A/Amorphous Carbon A | 13 | 85 |
| Example 2 | Graphite A/Amorphous Carbon B | 12 | 84 |
| Example 3 | Graphite B/Amorphous Carbon B | 10 | 80 |
| Example 4 | Graphite A/SiO | 18 | 90 |
| Com. Ex. 1 | Graphite A | 7 | 65 |
| Com. Ex. 2 | Graphite B | 5 | 65 |
| Com. Ex. 3 | Amorphous Carbon A | 22 | 70 |
| Com. Ex. 4 | Amorphous Carbon B | 19 | 70 |

*¹e1 represents the initial charge/discharge efficiency of lithium iron phosphate positive electrode and is 99%.
*²e2 represents the initial charge/discharge efficiency of negative electrode, see Table 2.
*³The increase in resistance is indicated relative to the resistance at a depth of discharge of 50%.

### Example 2

### Mixture of Graphite A and Amorphous Carbon B

Example 2 adopted a positive electrode plate W1 prepared by the procedure of Example 1. A negative-electrode active material used herein was a mixture of Graphite A and Amorphous Carbon B. Graphite A was as with one used in Example 1. Amorphous Carbon B showed an intensity ratio I_{1360 (D)}/I_{1580 (G)} of 1.0 as determined through Raman spectrometry and a specific surface area of 3 m²/g and had an initial charge capacity of 350 mAh/g and a discharge capacity of 280 mAh/g (charge/discharge efficiency of 80%). Graphite A and Amorphous Carbon B was mixed by weight ratio of 60:40. The specifications of the negative electrode had an initial charge capacity of 344 mAh/g, a negative-electrode initial charge/discharge efficiency e2 of 87%, and a difference x of 12%, as shown in Table 2. How the resistance varies depending on the depth of charge was determined to find that this sample had an available range of charge depth with a resistance change of 10% or less of 84%, approximately equal to that of Example 1, as shown in Table 3.

### Example 3

### Mixture of Graphite B and Amorphous Carbon B

Example 3 adopted a positive electrode plate W1 prepared by the procedure of Example 1. A negative-electrode active material used herein was a mixture of Graphite B and Amorphous Carbon B. Graphite B showed an interlayer distance d₀₀₂ of 3.370 angstroms as determined through X-ray powder diffractometry and a specific surface area of 0.8 m²/g and had a charge capacity of 340 mAh/g and a discharge capacity of 320 mAh/g (initial charge/discharge efficiency: 94%). Amorphous Carbon B was as with one used in Example 2. Graphite B and Amorphous Carbon B was mixed by weight ratio of 65:35. With reference to Table 2, the specifications of the negative electrode had an initial charge capacity of 344 mAh/g, a negative-electrode initial charge/discharge efficiency e2 of 89%, and a difference x of 10%. How the resistance varies depending on the depth of charge was determined to find that this sample had an available range of charge depth with a resistance change of 10% or less of 80%, as shown in Table 3.

### Example 4

### Mixture of Graphite A and Silicon Oxide

Example 4 adopted a positive electrode plate W1 prepared by the procedure of Example 1. A negative-electrode active material used herein was a mixture of Graphite A and SiO. Graphite A was as with one used in Example 1. The silicon oxide had a charge capacity of 2028 mAh/g, a discharge capacity of 1500 mAh/g, and an initial charge/discharge efficiency of 74%. Graphite A and the silicon oxide was mixed by weight ratio of 80:20. A silicon oxide (SiO) for use herein is preferably one having a specific surface area of 2 m²/g or more and 10 or less, for higher reactivity. In this example, SiO having a specific surface area of 6 m²/g was used. With reference to Table 2, the specifications of the negative electrode had an initial charge capacity of 702 mAh/g, a negative-electrode initial charge/discharge efficiency e2 of 81%, and a difference x of 18%. How the resistance varies depending on the depth of charge was determined to find that this sample had an available range of charge depth with a resistance change of 10% or less of 90%, as shown in Table 3.

### Comparative Example 1

### Graphite A Alone

Comparative Example 1 adopted a positive electrode plate W1 prepared by the procedure of Example 1. A negative-electrode active material used herein was Graphite A alone, the same as one used in Example 1. With reference to Table 2, the specifications of the negative electrode had an initial charge capacity of 370 mAh/g, a negative-electrode initial charge/discharge efficiency e2 of 92%, and a difference x of 7%. How the resistance varies depending on the depth of charge was determined to find that this sample had an available range of charge depth with a resistance change of 10% or less of 65%, as shown in Table 3.

### Comparative Example 2

### Graphite B Alone

Comparative Example 2 adopted a positive electrode plate W1 prepared by the procedure of Example 1. A negative-electrode active material used herein was Graphite B alone which was the same as in Example 3. With reference to Table 2, the specifications of the negative electrode had an initial charge capacity of 340 mAh/g, a negative-electrode initial charge/discharge efficiency e2 of 94%, and a difference x of 5%. How the resistance varies depending on the depth of charge was determined to find that this sample had an available range of charge depth with a resistance change of 10% or less of 65% as shown in Table 3.

### Comparative Example 3

### Amorphous Carbon A Alone

Comparative Example 3 adopted a positive electrode plate W1 prepared by the procedure of Example 1. A negative-electrode active material used herein was Amorphous Carbon A alone which was the same as in Example 1. With reference to Table 2, the specifications of the negative electrode had an initial charge capacity of 450 mAh/g, a negative-electrode initial charge/discharge efficiency e2 of 77%, and a difference x of 22%. How the resistance varies depending on the depth of charge was determined to find that this sample had an available range of charge depth with a resistance change of 10% or less of 70% as shown in Table 3. This is probably because the amorphous carbon used as the negative electrode itself had a direct-current resistance gradually increasing in the latter half of discharging, and this caused the battery to have a narrower available range of charge depth with a direct-current resistance change of 10% or less.

### Comparative Example 4

### Amorphous Carbon B Alone

Comparative Example 4 adopted a positive electrode plate W1 prepared by the procedure of Example 1. A negative-electrode active material used herein was Amorphous Carbon B alone which was the same as in Example 2. With reference to Table 2, the specifications of the negative electrode had an initial charge capacity of 350 mAh/g, a negative-electrode initial charge/discharge efficiency e2 of 80%, and a difference x of 19%. How the resistance varies depending on the depth of charge was determined to find that this sample had an available range of charge depth with a resistance change of 10% or less of 70% for the same reason as in Comparative Example 3, as shown in Table 3.

With reference to Table 3, a comparison of Examples 1, 2, and 4 with Comparative Example 1 and a comparison of Example 3 with Comparative Example 2 demonstrate that a battery system using lithium iron phosphate in a positive electrode less suffers from resistance increase in a wider available range of discharge depth and thereby has a wider available capacity range by adopting a graphite as a principal component of a negative-electrode active material, allowing the negative electrode to have a negative-electrode initial charge/discharge efficiency e2 satisfying e2=e1−x (wherein e1 represents the positive-electrode initial charge/discharge efficiency; and 10≦x≦20), and thereby restricting the region where the resistance of the lithium iron phosphate increases during discharging.

In contrast, a comparison between Comparative Example 3 and Comparative Example 4 demonstrates that an amorphous carbon material or low-crystallinity carbon material used as a principal component of a negative-electrode active material does not contribute to reduction in resistance increase in a wide available range of discharge depth and fails to show a wide available capacity range, even when the negative electrode has a negative-electrode initial charge/discharge efficiency e2 satisfying e2=e1−x (wherein e1 represents the positive-electrode initial charge/discharge efficiency; and 10≦x≦20). This is probably because the resulting negative electrode composed of the amorphous carbon material or low-crystallinity carbon material shows a resistance gradually increasing from the latter half of discharging. Specifically, a battery system adopting a lithium iron phosphate positive electrode can less suffer from resistance increase in a wider available range of discharge depth by using a negative electrode having such specifications as to have a negative-electrode initial charge/discharge efficiency e2 satisfying e2=e1−x (wherein e1 represents the positive-electrode initial charge/discharge efficiency; and 10≦x≦20), and by using a graphite material as a principal component of a negative-electrode active material. This gives a lithium ion secondary battery which adopts such highly thermally stable lithium iron phosphate positive electrode and has a higher energy density.

### INDUSTRIAL APPLICABILITY

The present invention provides nonaqueous electrolyte secondary batteries having a wider available range of depth of discharge and thereby showing a higher energy density, thereby contributes to production and distribution of nonaqueous electrolyte secondary batteries, and has industrial applicability.

### REFERENCE SIGNS LIST

6 electrode group
20 cylindrical lithium ion secondary battery (nonaqueous electrolyte secondary battery)
W1 positive electrode plate
W2 positive-electrode mixture layer
W3 negative electrode plate
W4 negative-electrode mixture layer

1. A nonaqueous electrolyte secondary battery comprising a positive electrode, a negative electrode and a nonaqueous electrolyte,
wherein the positive electrode includes a lithium metal phosphate represented by a chemical formula LiMPO₄ (wherein M represents at least one metal element selected from the group consisting of Fe, Mn, Ni and Co) as a positive-electrode active material;
wherein the negative electrode includes a graphite material as a negative-electrode active material; and
wherein the negative electrode has an initial charge/discharge efficiency of e2, the positive electrode has an initial charge/discharge efficiency of e1, and e1 and e2 satisfy a relation of formula e2=e1−x (10≦x≦20).

2. The nonaqueous electrolyte secondary battery according to claim 1,
wherein the lithium metal phosphate is a carbon-hybridized lithium metal phosphate.

3. The nonaqueous electrolyte secondary battery according to claim 2,
wherein the carbon-hybridized lithium metal phosphate contains carbon in a content of 1 percent by weight or more and 5 percent by weight or less.

4. The nonaqueous electrolyte secondary battery according to claim 2,
wherein the lithium metal phosphate has a ratio Li/M of the lithium Li content to the metal element M content of 0.70 or more and 0.80 or less when the battery is discharged to a battery voltage of 2.0 V.

5. The nonaqueous electrolyte secondary battery according to claim 1,
wherein the negative electrode comprises a negative-electrode active material containing 60 percent by weight or more of the graphite material and 40 percent by weight or less of a carbon material.

6. The nonaqueous electrolyte secondary battery according to claim 5,
wherein the graphite material has an interlayer distance d₀₀₂ of 0.3335 nm or more and 0.3375 nm or less as determined through X-ray powder diffractometry and has a specific surface area of 0.5 m²/g or more and 4 m²/g or less, and wherein the carbon material is an amorphous carbon or nongraphitizable carbon having an intensity ratio I_{1360 (D)}/I_{1580 (G)} of an intensity at 1360 (D) cm⁻¹ to an intensity at 1580 (G) cm⁻¹ of 0.8 or more and 1.2 or less as determined through Raman spectrometry and having a specific surface area of 2 m²/g or more and 6 m²/g or less.

7. The nonaqueous electrolyte secondary battery according to claim 1,
wherein the negative electrode comprises a negative-electrode active material containing 80 percent by weight or more of the graphite material and 20 percent by weight or less of a silicon oxide material.

8. The nonaqueous electrolyte secondary battery according to claim 7,
wherein the graphite material has an interlayer distance d₀₀₂ of 0.3335 nm or more and 0.3375 nm or less as determined through X-ray powder diffractometry and has a specific surface area of 0.5 m²/g or more and 4 m²/g or less, and wherein the silicon oxide material has a specific surface area of 2 m²/g or more and 10 m²/g or less.

9. A lithium ion secondary battery comprising an electrode group; and a battery case housing the electrode group therein,
wherein the electrode group includes a positive electrode plate, a negative electrode plate and a separator disposed in a space between the positive electrode plate and the negative electrode plate, and the electrode group is wound,
wherein the positive electrode plate includes a positive electrode substrate; and a positive-electrode mixture layer arranged on the positive electrode substrate,
wherein the negative electrode plate includes a negative electrode substrate; and a negative-electrode mixture layer arranged on the negative electrode substrate,
wherein the positive-electrode mixture layer contains a lithium metal phosphate compound represented by a chemical formula LiMPO₄ (wherein M represents at least one metal element selected from the group consisting of Fe, Mn, Ni and Co) as a positive-electrode active material,
wherein the negative-electrode mixture layer contains a graphite and an amorphous carbon material as negative-electrode active materials, and
wherein the negative electrode plate has an initial charge/discharge efficiency of e2, the positive electrode plate has an initial charge/discharge efficiency of e1, and e1 and e2 satisfy a relation of formula e2=e1−x (10≦x≦20).

10. The lithium ion secondary battery according to claim 9,
wherein the lithium metal phosphate is a carbon-hybridized lithium metal phosphate.

11. The lithium ion secondary battery according to claim 10,
wherein the carbon-hybridized lithium metal phosphate contains carbon in a content of 1 percent by weight or more and 5 percent by weight or less.

12. The lithium ion secondary battery according to claim 9,
wherein the lithium metal phosphate has a ratio Li/M of the lithium Li content to the metal element M content of 0.70 or more and 0.80 or less when the battery is discharged to a battery voltage of 2.0 V.

13. The lithium ion secondary battery according to claim 9,
wherein the negative electrode comprises a negative-electrode active material including 60 percent by weight or more of a graphite material and 40 percent by weight or less of a carbon material.

14. The lithium ion secondary battery according to claim 13,
wherein the graphite material has an interlayer distance d₀₀₂ of 0.3335 nm or more and 0.3375 nm or less as determined through X-ray powder diffractometry and has a specific surface area of 0.5 m²/g or more and 4 m²/g or less, and wherein the carbon material is an amorphous carbon or nongraphitizable carbon having an intensity ratio I_{1360 (D)}/I_{1580 (G)} of an intensity at 1360 (D) cm⁻¹ to an intensity at 1580 (G) cm⁻¹ of 0.8 or more and 1.2 or less as determined through Raman spectrometry and having a specific surface area of 2 m²/g or more and 6 m²/g or less.

15. The lithium ion secondary battery according to claim 9,
wherein the negative electrode comprises a negative-electrode active material including 80 percent by weight or more of a graphite material and 20 percent by weight or less of a silicon oxide material.

16. The lithium ion secondary battery according to claim 15,
wherein the graphite material has an interlayer distance d₀₀₂ of 0.3335 nm or more and 0.3375 nm or less as determined through X-ray powder diffractometry and has a specific surface area of 0.5 m²/g or more and 4 m²/g or less, and wherein the silicon oxide material has a specific surface area of 2 m²/g or more and 10 m²/g or less.
